(19) United States
(12) Patent Application Publication
(10) Pub. No.: US 2024/0369849 A1
(43) Pub. Date: Nov. 7, 2024

(54) FRAME ASSEMBLIES FOR HEAD-MOUNTED DISPLAYS

(71) Applicant: Meta Platforms Technologies, LLC, Menlo Park, CA (US)

(72) Inventors: Peter Wesley Bristol, Seattle, WA (US); Luke Fryer, Seattle, WA (US); Rolando Abella Pausal, Kirkland, WA (US); Joel Bernard Jacobs, Seattle, WA (US); David Michael Pickett, Seattle, WA (US); Enric Vial Roig, Seattle, WA (US); Yi-yaun Chen, Seattle, WA (US); Scott Andrew Dallmeyer, Seattle, WA (US); Shane Michael Ellis, Bellevue, WA (US); Glen Jason Tompkins, Woodinville, WA (US); Joseph Patrick Sullivan, Seattle, WA (US); Mauricio Romano, Redmond, WA (US)

(21) Appl. No.: 18/312,183

(22) Filed: May 4, 2023

(51) Int. Cl. G02B 27/01; G06F 1/16

(52) U.S. Cl. CPC G02B 27/0176; G06F 1/163; G02B 2027/0156; G02B 2027/0178

(57) ABSTRACT

Frame assemblies for a head-mounted display may include a facial interface frame, a display support frame, and at least one extendible tab coupled to the facial interface frame and the display support frame. The at least one extendible tab may be movable between a retracted position at which a near-eye display supported by the display support frame is located a first distance from the facial interface frame and a second position at which the near-eye display is located at a second, greater distance from the facial interface frame. Various other methods, head-mounted displays, frames and frame elements, and systems are also disclosed.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a top view of a frame for a head-mounted display, according to at least one embodiment of the present disclosure.

FIG. 2 is a top perspective view of a frame assembly for a head-mounted display in a retracted state, according to at least one embodiment of the present disclosure.

FIG. 3 is a top perspective view of the frame assembly of FIG. 2 in an extended state, according to at least one embodiment of the present disclosure.

FIG. 4 is a top perspective view of a frame for a head-mounted display, according to at least one additional embodiment of the present disclosure.

FIG. 5 is a bottom perspective view of a frame for a head-mounted display, according to at least one further embodiment of the present disclosure.

FIG. 6 is a perspective view of an extendible tab, according to at least one embodiment of the present disclosure.

FIG. 7A is a detailed perspective view of an extendible tab assembled with a frame and in a retracted position, according to at least one embodiment of the present disclosure.

FIG. 7B is a detailed perspective view of the extendible tab assembled with the frame and in an extended position, according to at least one embodiment of the present disclosure.

FIG. 8 is a cross-sectional side view of an extendible tab assembled with a frame and in an extended position, according to at least one embodiment of the present disclosure.

FIG. 9 is a bottom perspective view of a frame for a head-mounted display, according to at least one additional embodiment of the present disclosure.

FIG. 10 is a bottom perspective view of a frame for a head-mounted display, according to at least one further embodiment of the present disclosure.

FIG. 11 is a perspective view of a frame for a head-mounted display, according to another embodiment of the present disclosure.

FIG. 12 is an illustration of example augmented-reality glasses that may be used in connection with embodiments of this disclosure.

FIG. 13 is an illustration of an example virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Head-mounted display systems include a near-eye display (NED) element positioned directly in front of a user's eyes. Artificial-reality systems (e.g., virtual-reality, augmented-reality, mixed-reality, or hybrid-reality systems) often employ head-mounted display systems to present images (e.g., stereoscopic images) of virtual objects or scenes to the user. The virtual objects or scenes may be part of an entirely virtual environment viewed by the user or they may overlay views of a real-world environment surrounding the user.

When worn by the user, head-mounted displays can be supported on the user's head in a variety of ways. For example, a head strap may wrap circumferentially around the user's head and/or over a top of the user's head.

At least a portion of the weight of the head-mounted displays can be held in front of the user's face. This weight and pressure against the user's face may cause discomfort on the user's head, face, and nose, particularly after a long period of use. Foam or other conformable features can be included on facial interfaces of some head-mounted displays to improve user comfort. However, different users have faces and heads with features in a wide variety of sizes and shapes, which can make it difficult to design a head-mounted display that can be comfortable for a range of different users. Additionally, the displays and frames may be rigid and non-conformable to the user's facial features, sometimes resulting in pressure points and/or gaps between the facial interfaces and the user's face.

For users with glasses, some head-mounted display frames may include a spacer insert that can be positioned between a facial interface frame and display support frame. The spacer insert increases the eye relief, which is the distance between the user's eyes and the NED, to allow additional space for glasses. Such spacer inserts are separate pieces, which may be susceptible to loss or breakage when uncoupled from the frames.

The present disclosure is generally directed to frames for head-mounted displays that can conform to a variety of different users' facial features that may have corresponding different sizes. As will be explained in greater detail below, embodiments of the present disclosure may include a frame that has a front frame portion, a flexible facial interface frame portion, and two upper support elements that connect the front frame portion and the facial interface frame portion. Outer peripheral regions of the facial interface frame portion may be configured to flex (e.g., forward and/or backward) to conform to a user's facial features when in use. The two upper support elements may intersect with the facial interface frame portion respectively at a first intersection point and a second intersection point. The first and second intersection points may be separated by a distance between 50 mm and 75 mm, such as at a common (e.g., median or average) interpupillary distance (IPD) of multiple users.

By separating the upper support elements at an average IPD of multiple users, any flexing of the facial interface frame portion may not affect, or may affect only slightly, a distance between the user's eyes and the display supported by the frame. For example, the upper support elements may maintain a distance between the facial interface frame portion at the first and second intersection points and the front frame portion, even when outer peripheral regions of the frame flex forward and/or backward to conform to a user's facial features. Since the upper support elements maintain this distance, images on the display may remain in focus relative to the user's eyes, even for multiple different users with a variety of face shapes and sizes.

The present disclosure also relates to frames for head-mounted displays that include extendible tabs that are movable for additional eye relief, such as to accommodate glasses. The extendible tabs can be mounted to a facial interface frame element and can couple the facial interface frame element to a display (e.g., through a display support frame). When additional eye relief is desired, such as for a user wearing glasses, the tabs can be extended, thereby increasing an eye relief and providing space for glasses.

Features from any of the embodiments described herein may be used in combination with one another in accordance with the general principles described herein. These and other embodiments, features, and advantages will be more fully understood upon reading the following detailed description in conjunction with the accompanying drawings and claims.

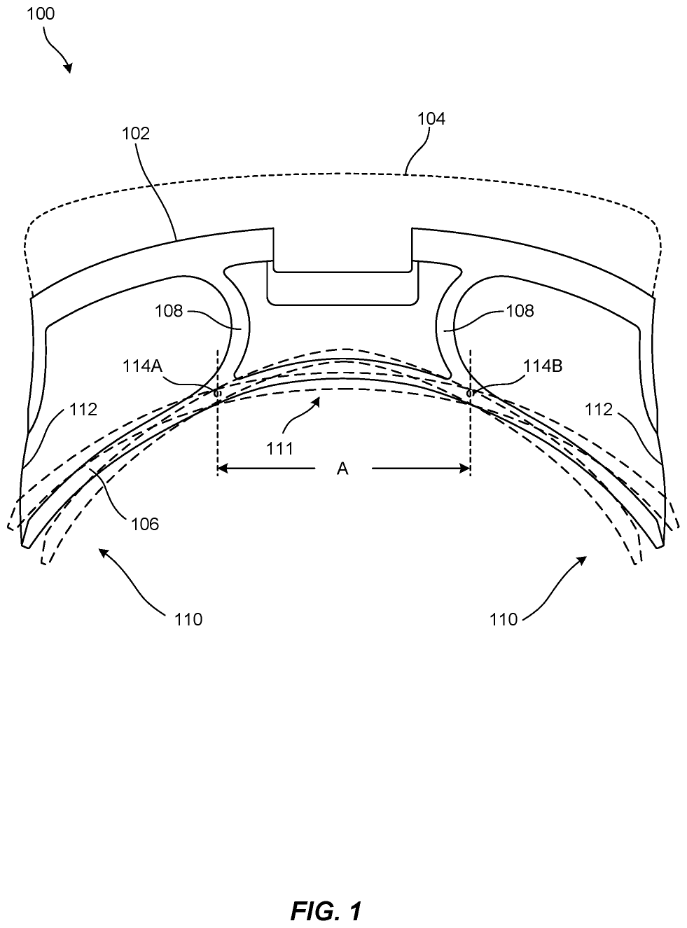

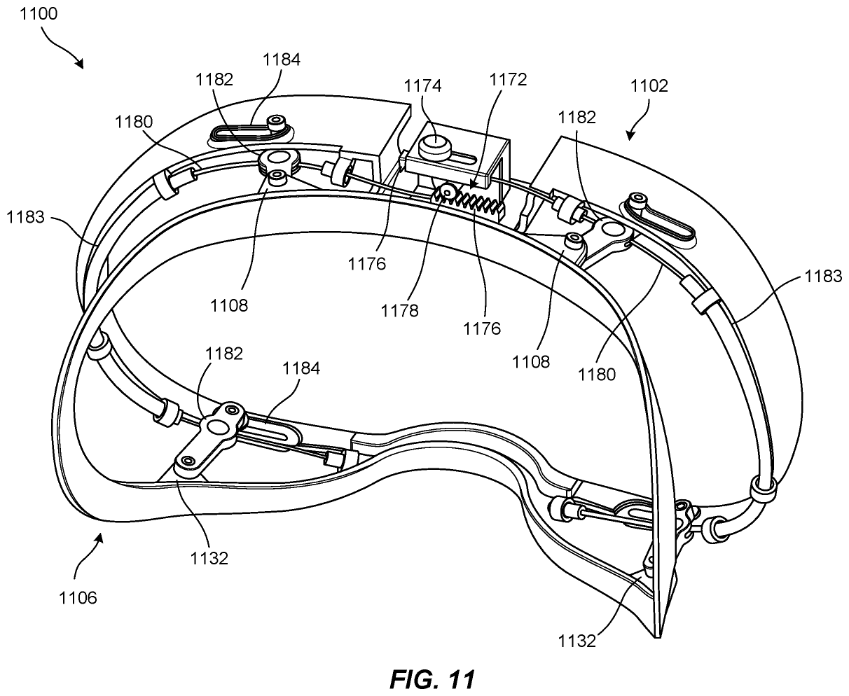

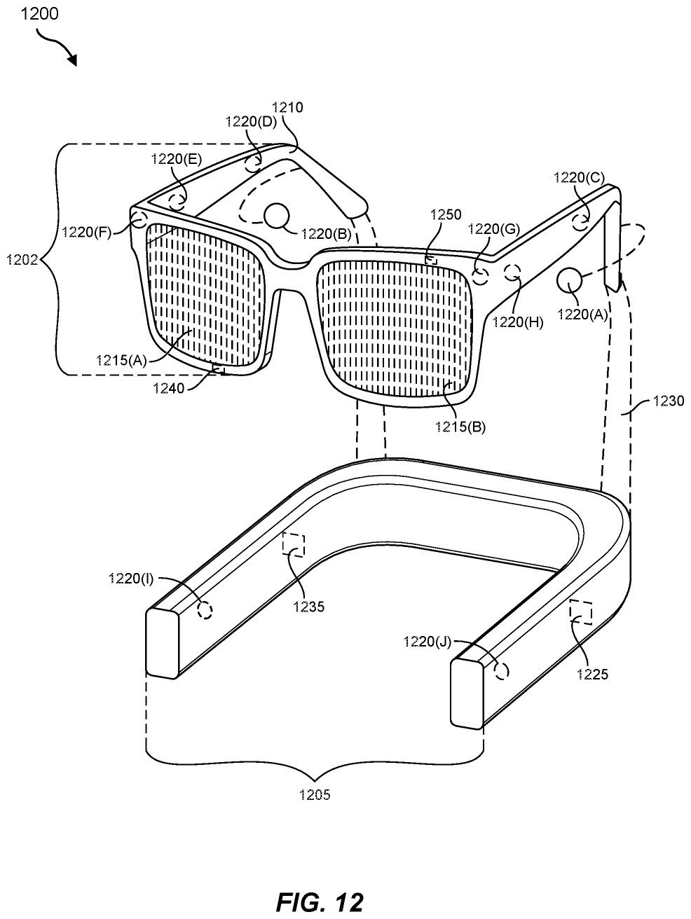

The following will provide, with reference to FIGS. 1-10, detailed descriptions of various example frames for head-mounted displays and components thereof. Example artificial-reality systems that may be used in connection with embodiments of this disclosure will then be described with reference to FIGS. 11 and 12.

FIG. 1 is a top view of a frame 100 for a head-mounted display, according to at least one embodiment of the present disclosure. The frame 100 may include a front frame portion 102, which may be dimensioned to physically support a near-eye display (NED) 104 for displaying an image (e.g., a stereoscopic image) to a user when wearing the head-mounted display. The frame 100 may also include a flexible facial interface frame portion 106 and two upper support elements 108 that connect an upper portion of the front frame portion 102 and an upper portion of the facial interface frame portion 106.

Outer peripheral regions 110 of the facial interface frame portion 106 may be configured to flex (e.g., forward and backward relative to a user's face) to conform to a user's facial features when the frame 100 rests against the user's face. For example, the frame 100 may lack any physical supports between the outer peripheral regions 110 and the front frame portion 102 (e.g., laterally outside of the upper support elements 108) that might otherwise restrict the flexing of the outer peripheral regions 110. In addition, the outer peripheral regions 110 may exhibit characteristics (e.g., geometry, material type, etc.) that facilitate flexing. A central region 111 of the facial interface frame portion 106 between the upper support elements 108 may also be configured to flex (e.g., forward and backward), such in conjunction with the flexing of the outer peripheral regions 110. For example, when the outer peripheral regions 110 flex forward, the central region 111 may flex backward. Similarly, when the outer peripheral regions 110 flex backward, the central region 111 may flex forward. Such flexing of the central region 111 forward and backward is illustrated in FIG. 1 by dashed lines.

In some examples, an extensible material 112 (e.g., a flexible fabric material) may be disposed between the front frame portion 102 and the facial interface fame portion 106, including the outer peripheral regions 110 thereof. The extensible material 112 may provide improved aesthetics, a block against light entering the frame 100 from a side of the frame 100, and/or a block against particles (e.g., dust) from entering the frame 100. However, the extensible material 112 may result in little or no resistance to flexing of the outer peripheral regions 110 relative to the front frame portion 102.

Optionally, a foam material (or other similar conformable or soft material) may be positioned on the facial interface frame portion 106 for comfort when the frame 100 rests against the user's face.

The upper support elements 108 may intersect with the facial interface frame portion 106 respectively at a first intersection point 114A and a second intersection point 114B (collectively referred to as “intersection points 114”). For purposes of illustration, the intersection points 114 may be identified at a location where a centerline of the upper support elements 108 cross a centerline of the facial interface frame portion 106.

A distance A between the intersection points 114 may be selected to match a common interpupillary distance (IPD) of expected users. For example, the distance A may be between 50 mm and 75 mm, such as between 64 mm and 68 mm. In one example, the distance A may be about 66 mm, such as to correspond to an average or median IPD of adult users. In additional examples, the distance A may have a different value, such as to correspond to younger users or another subset of expected users that may typically have smaller or larger median IPDs.

By positioning the upper support elements 108 to intersect with the facial interface frame portion 106 at or near a median IPD of expected users, an eye relief distance from the eyes of the user to the NED 104 may be kept substantially constant across various users with different head and face sizes, which would result in flexing of the facial interface frame portion 106 as described above and as shown in FIG. 1. This substantially constant eye relief distance may substantially maintain a focal distance across the various users and may facilitate other operational and manufacturing parameters for head-mounted displays that can be used by many different users.

In some examples, the terms “substantially” or “about” in reference to a given parameter, property, or condition, may refer to a degree that one skilled in the art would understand that the given parameter, property, or condition is met with a small degree of variance, such as within acceptable manufacturing tolerances. For example, a parameter that is “substantially” met or that is “about” met may be at least about 90% met, at least about 95% met, at least about 99% met, or fully met.

As illustrated in FIG. 1, the upper support elements 108 may be curved laterally inward. This curvature may facilitate flexing of the facial interface frame portion 106, such as compared to support elements that are straight. For example, the curved upper support elements 108 may act as a curved leaf spring, enabling at least some rotation of the upper support elements 108 along their curvature, which in turn may result in additional flexibility of the facial interface frame portion 106.

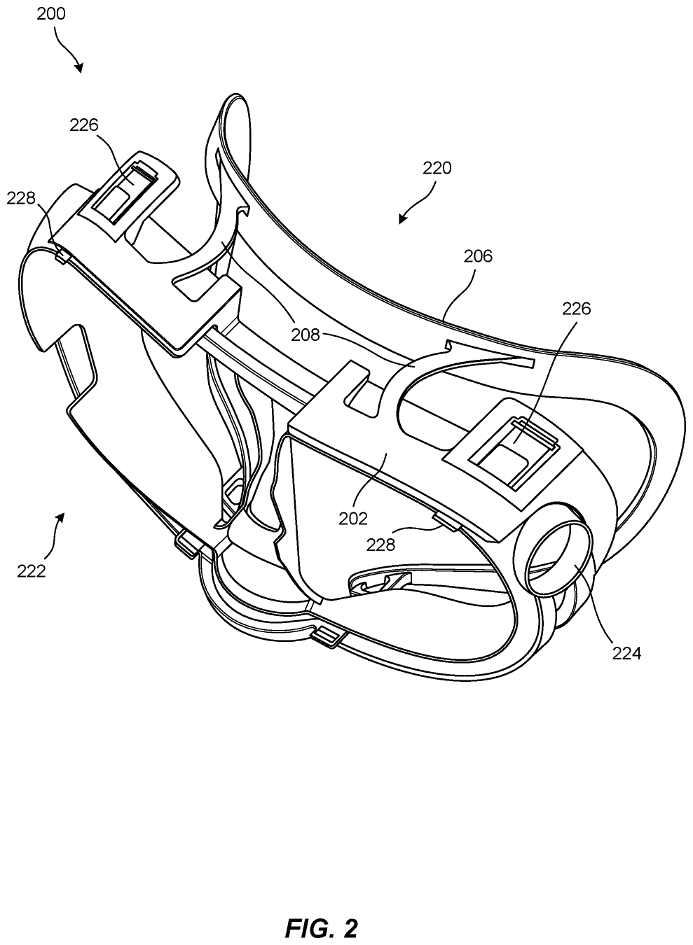

FIG. 2 is a top perspective view of a frame assembly 200 for a head-mounted display in a retracted state, according to at least one embodiment of the present disclosure. The frame assembly 200 may include a facial interface frame body 220 and a display interface frame body 222 that is separate from and assembled to the facial interface frame body 220. In some respects, the facial interface frame body 220 may be similar to the frame 100 described above with reference to FIG. 1. For example, the facial interface frame body 220 may include a front frame portion 202, a flexible facial interface frame portion 206, and two upper support elements 208 that connect an upper portion of the front frame portion 202 to an upper portion of the facial interface frame portion 206.

The display interface frame body 222 may be configured for supporting an NED and may act as an intermediate support structure between the NED and the facial interface frame body 220. The display interface frame body 222 may include strap engagement elements 224. The strap engagement elements 224 may be configured (e.g., shaped and sized) for coupling a strap to the frame assembly 200, such as a strap that can wrap around and/or over a user's head to support the NED in front of the user's eyes.

As illustrated in FIG. 2, in some embodiments, the facial interface frame body 220 may be coupled to the display interface frame body 222 via extendible tabs 226. The extendible tabs 226 may be secured (e.g., removably secured) to coupling points 228 of the display interface frame body 222. The extendible tabs 226 may be configured to move (e.g., extend and retract) relative to the facial interface frame body 220 to alter a position of the facial interface frame body 220 relative to the display interface frame body 222 and, consequently, relative to an NED supported by the display interface frame body 222. For example, the position of the facial interface frame body 220 may correspond to an eye relief between the user's eyes and the NED. An increased eye relief, which may be achieved by extending the extendible tabs 226, may be appropriate for a user wearing eyeglasses to enable the eyeglasses to fit between the user's eyes and components (e.g., lenses) of a head-mounted display including the frame assembly 200. In FIG. 2, the extendible tabs 226 are shown in a retracted position, such as for a user who is not wearing eyeglasses.

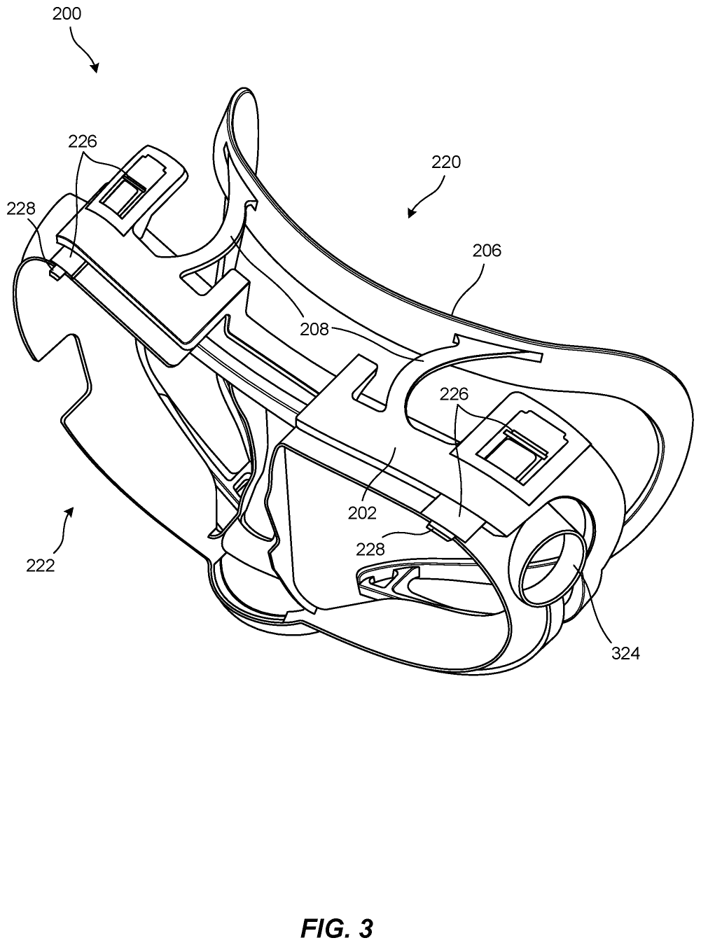

FIG. 3 is a top perspective view of the frame assembly 200 of FIG. 2 in an extended state, according to at least one embodiment of the present disclosure. In FIG. 3, the extendible tabs 226 have been extended compared to the state in FIG. 2. Due to the connection of the extendible tabs 226 to the display interface frame body 222 at the coupling points 228, at least a portion of the display interface frame body 222 (e.g., an upper portion) may be moved away from the facial interface frame body 220. As noted above, this extension of the extendible tabs 226 may provide additional space between a user's eyes and components (e.g., lenses) of an associated head-mounted display, such as to accommodate eyeglasses worn by the user.

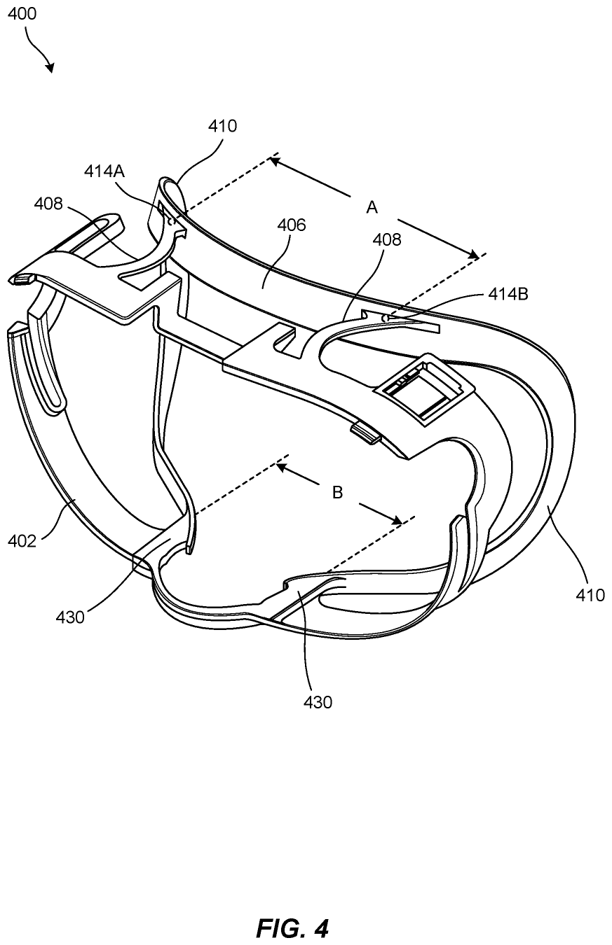

FIG. 4 is a top perspective view of a frame 400 for a head-mounted display, according to at least one additional embodiment of the present disclosure. In some respects, the frame 400 may be similar to the frame 100 described above with reference to FIG. 1. For example, the frame 400 may include a front frame portion 402, a flexible facial interface frame portion 406, and two upper support elements 408 that connect an upper portion of the front frame portion 402 to an upper portion of the facial interface frame portion 406. The two upper support elements 408 and the facial interface frame portion 406 may respectively intersect at a first intersection point 414A and a second intersection point 414B. The first and second intersection points 414A, 414B (collectively referred to as intersection points 414) may be separated by a distance A, which may correspond to a common IPD of expected users. For example, the distance A may be between 50 mm and 75 mm, such as between 64 mm and 68 mm, such as about 66 mm, etc.

In some examples, the frame 400 may include at least one lower support element 430 connecting a lower portion of the front frame portion 402 and a lower portion of the facial interface frame portion 406. For example, as illustrated in FIG. 4, the frame 400 may include two lower support elements 430. The two lower support elements 430 may be separated by a distance B, which may be less than a distance A between the intersection points 414. The distance B may be selected for positioning on opposing sides of a user's nose, for example. This configuration, with the two lower support elements 430 in a central region of the frame 400, may improve a flexibility of outer peripheral regions 410 of the facial interface frame portion 406. This improved flexibility may result from the frame 400 lacking any support elements laterally outside of the upper support elements 408 that would otherwise provide resistance against the outer peripheral regions 410 flexing to conform to a user's face.

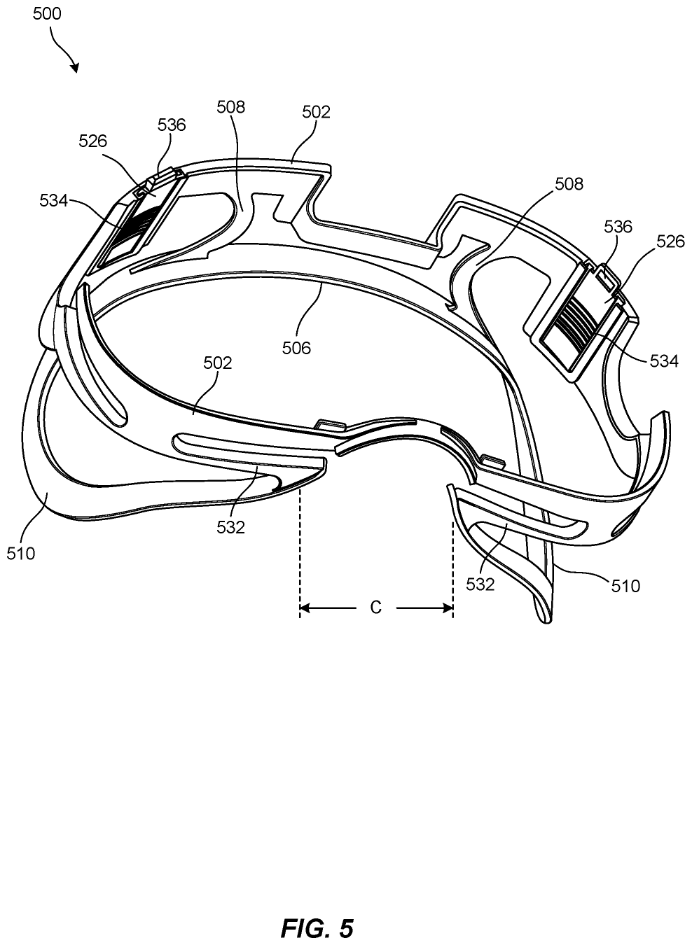

FIG. 5 is a bottom perspective view of a frame 500 for a head-mounted display, according to at least one further embodiment of the present disclosure. In some respects, the frame 500 may be similar to the frame 100 described above with reference to FIG. 1. For example, the frame 500 may include a front frame portion 502, a flexible facial interface frame portion 506, and two upper support elements 508 that connect an upper portion of the front frame portion 502 to an upper portion of the facial interface frame portion 506.

As illustrated in FIG. 5, two elongated lower support elements 532 may connect a lower portion of the front frame portion 502 and a lower portion of the facial interface frame portion 506. The elongated lower support elements 532, at points where the elongated lower support elements 532 connect to the facial interface frame portion 506, may be separated by a distance C less that is than a distance between the upper support elements 508. However, the elongated lower support elements 532 may extend laterally outward before connecting to the front frame portion 502. This elongated configuration may provide additional flexibility to the facial interface frame portion 506, allowing outer peripheral regions 510 of the facial interface frame portion 506 to flex more easily to conform to a user's face.

FIG. 5 also illustrates an underside of extendible tabs 526 that may be movable for providing additional eye relief, such as to accommodate eyeglasses. The extendible tabs 526 are shown in FIG. 5 in a retracted position. The extendible tabs 526 may be configured for a user to press against the extendible tabs 526 to release them from the retracted position and slide them into an extended position, and vice versa. For example, the extendible tabs 526 may include a surface feature (e.g., knurling, ridges 534 (as shown in FIG. 5), a depression, a lip, surface roughness, etc.) to provide additional traction for the user to press and slide the extendible tabs 526 with a finger. The extendible tabs 526 may also include an engagement feature 536 for coupling (e.g., removably coupling) with coupling points of an associated frame body, such as the coupling points 228 of the display interface frame body 222 shown in FIG. 2.

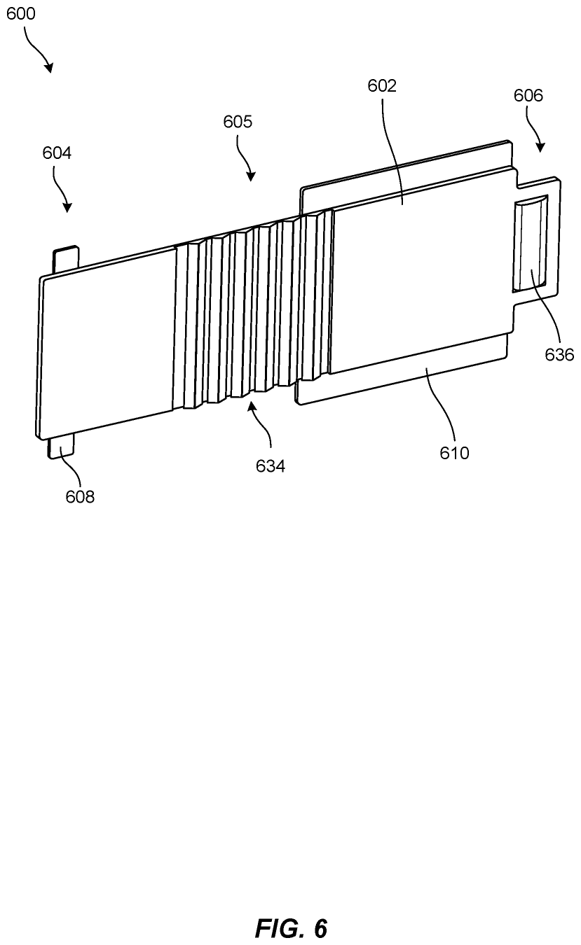

FIG. 6 is a perspective view of an extendible tab 600, according to at least one embodiment of the present disclosure. The extendible tab 600 may be suitable for use as any of the extendible tabs 226, 526 described above. The extendible tab 600 may be formed of a polymer material, a metal material, or a composite material, for example. The extendible tab 600 may be formed by molding, extruding, machining, stamping, or a combination thereof.

The extendible tab 600 may include a body 602 having a proximal end portion 604, a central portion 605, and a distal end portion 606. The proximal end portion 604 may include a locking protrusion 608. The locking protrusion 608 may be shaped and sized for abutting against corresponding locking surfaces of a frame body (e.g., the frame 100, the facial interface frame body 220, the frame 400, the frame 500, etc.) to lock into a retracted position, an extended position, and/or an intermediate position between fully retracted and extended positions.

The central portion 605 may include ridges 634 against which a user may press (e.g., with a finger) to bend the extendible tab 600 and disengage the locking protrusion 608 from against a corresponding locking surface of the associated frame body and to slide the extendible tab 600 between the retracted position and the extended position. The central portion 605 may also include flanges 610 that may be shaped and sized for positioning within respective grooves of the frame body. The extendible tab 600 may slide along the flanges 610 as the extendible tab 600 is moved between a retracted position and an extended position. In this manner, the extendible tab 600 may be shaped for being slidably coupled to a corresponding frame body.

The distal end portion 606 of the extendible tab 600 may include an engagement feature 636, such as a depression, tab, hook, hole, and/or extension, for coupling with a corresponding coupling point of a frame body (e.g., a coupling point 228 of the display interface frame body 222).

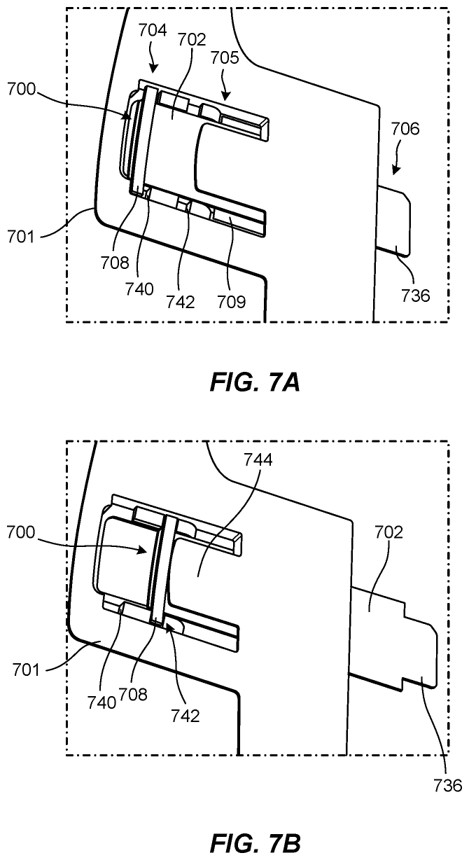

FIG. 7A is a detailed perspective view of an extendible tab 700 assembled with a frame 701 and in a retracted position, according to at least one embodiment of the present disclosure. The extendible tab 700 may be the same as or similar to the extendible tab 600 of FIG. 6. For example, the extendible tab 700 may include a body 702 including a proximal end portion 704, a central portion 705, and a distal end portion 706. The proximal end portion 704 may include a locking protrusion 708. The distal end portion 706 may include an engagement feature 736 for coupling to another frame body (e.g., a display interface frame body).

The frame 701 may include a retracted locking surface 740 and an extended locking surface 742, which may be in the form of side surfaces of blocks. A retention tab 744 may be positioned to retain the extendible tab 700 relative to the frame 701.

The locking protrusion 708 may be shaped and sized for abutting against the locking surfaces of a frame body (e.g., the frame 100, the facial interface frame body 220, the frame 400, the frame 500, etc.) to lock into a retracted position, an extended position, and/or an intermediate position. For example, the locking protrusion 708 may abut against the retracted locking surface 740 when the extendible tab 700 is in a retracted position. The locking protrusion 708 may abut against the extended locking surface 742 when the extendible tab 700 is in an extended position.

The central portion 705 of the extendible tab 700 may include flanges 709 shaped and sized to slide within corresponding grooves of the frame 701.

FIG. 7B is a detailed perspective view of the extendible tab 700 assembled with the frame 701 and in an extended position, according to at least one embodiment of the present disclosure. In operation, when a user wishes to move the extendible tab 700 from the retracted position (e.g., as shown in FIG. 7A) to the extended position (e.g., as shown in FIG. 7B), the user may push up on the extendible tab 700 such that the locking protrusion 708 clears the retracted locking surface 740. The extendible tab 700 may then be moved (e.g., slid) until the locking protrusion 708 abuts against the retention tab 744. The user may then release pressure from the extendible tab 700, allowing the locking protrusion 708 to drop into a position adjacent to (e.g., abutting) the extended locking surface 742. Resilience of the extendible tab 700 and/or of the retention tab 744 may result in a biasing force that drops the locking protrusion into the position adjacent to the extended locking surface 742.

Conversely, when the user wishes to move the extendible tab 700 from the extended position (e.g., as shown in FIG. 7B) to the retracted position (e.g., as shown in FIG. 7A), the user may again push up on the extendible tab 700 and slide the extendible tab 700 toward the retracted position. The user may then release the extendible tab 700 and allow the locking protrusion 708 to drop into a position adjacent to (e.g., abutting against) the retracted locking surface 740.

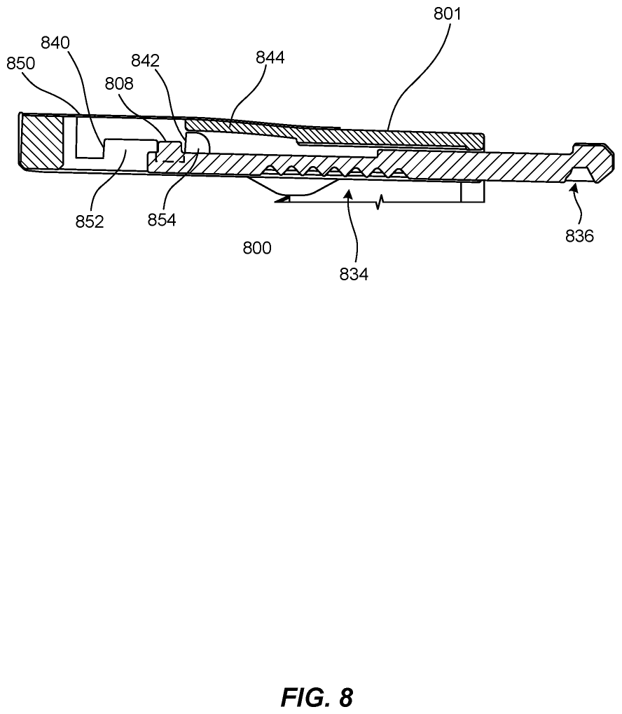

FIG. 8 is a cross-sectional side view of an extendible tab 800 assembled with a frame 801 and in an extended position, according to at least one embodiment of the present disclosure. The extendible tab 800 and frame 801, respectively, may be similar to the extendible tab 700 and frame 701 discussed above with reference to FIGS. 7A and 7B. For example, the extendible tab 800 may include a locking protrusion 808 at a proximal end portion thereof and an engagement feature 836 at a distal end portion thereof. The frame 801 may include a retracted locking surface 840 and an extended locking surface 842. A retention tab 844 may be positioned to retain the extendible tab 800 relative to the frame 801.

As illustrated in FIG. 8, the extendible tab 800 may also include ridges 834 to provide additional grip for a user's finger to interact with the extendible tab 800, such as to apply pressure to the extendible tab 800 and/or to slide the extendible tab 800 between the extended position and a retracted position.

The frame 801 may also include a cover 850 positioned over a receptacle containing the extendible tab 800. The cover 850 may keep the extendible tab 800 within the receptacle, providing a stop to inhibit removal of the extendible tab 800 that might otherwise occur if the extendible tab 800 is pressed upward by a user too far.

The retracted locking surface 840 may be a side surface of a first block 852. The extended locking surface 842 may be a side surface of a second block 854. When the extendible tab 800 is in the extended position, the locking protrusion 808 may be positioned in a groove between the first block 852 and the second block 854 (e.g., as shown in FIG. 8) and adjacent to the extended locking surface 842. When the extendible tab 800 is in the retracted position, the locking protrusion 808 may be positioned in a groove adjacent to the first block 852 and the retracted locking surface 840 thereof.

To move the extendible tab 800 between the extended position and the retracted position, a user may press the extendible tab 800 (e.g., at the ridges 834) upward to bend the extendible tab 800 until the locking protrusion 808 clears the first block 852. Then the extendible tab 800 may be moved (e.g., slid) over and across the first block 852 to an opposite side of the first block 852.

In each of the examples discussed above with reference to FIGS. 2-8, an associated display may be moved away from the user's eyes by extending the extendible tabs of the frame, such as to provide space for eyeglasses. Since the extendible tabs are located in an upper portion of the frame, the display element may tilt relative to the frame as the extendible tabs are extended and the display pivots about a lower portion of the frame. This tilting may be minor enough that the user can still perceive images on the display with little or no effect to viewing quality.

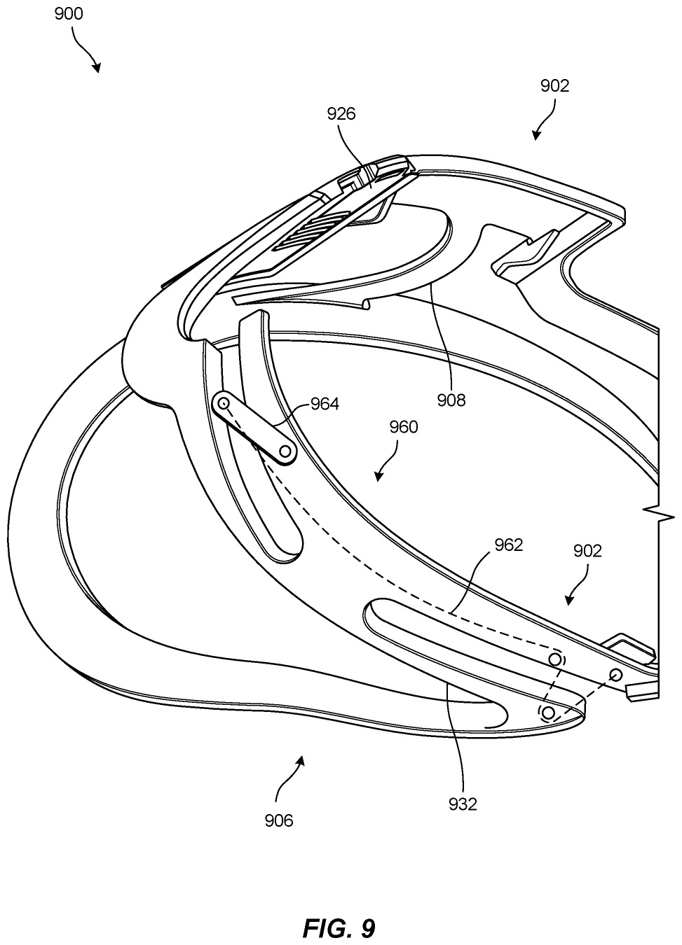

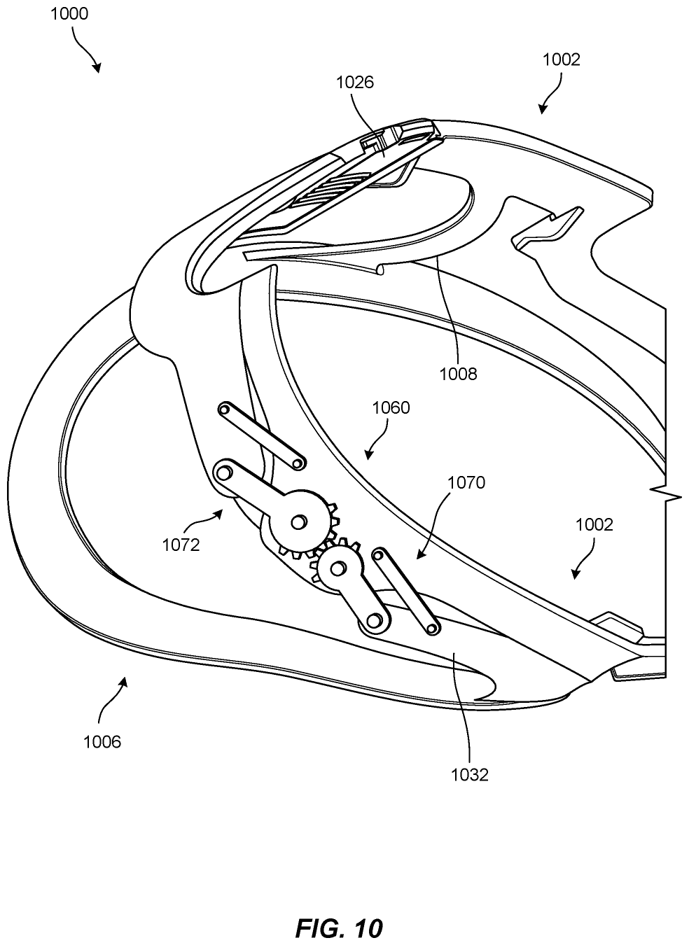

In additional examples, such tilting may be inhibited (e.g., reduced or eliminated) by concurrently increasing a lower distance between a facial interface element and the display when an upper distance is increased by extending the extendible tabs. FIGS. 9 and 10 illustrate two example mechanisms that may be employed to inhibit tilting of the display.

FIG. 9 is a bottom perspective view of a frame 900 for a head-mounted display, according to at least one additional embodiment of the present disclosure. In some respects, the frame 900 may be similar to the frame 500 discussed above with reference to FIG. 5. For example, the frame 900 may include a front frame portion 902, a flexible facial interface frame portion 906, and two upper support elements 908 that connect an upper portion of the front frame portion 902 and an upper portion of the facial interface frame portion 906. Two elongated lower support elements 932 may connect a lower portion of the front frame portion 902 and a lower portion of the facial interface frame portion 906.

The frame 900 may also include extendible tabs 926 for adjusting a distance between an upper portion of the facial interface frame portion 906 (and, consequently, a user's eyes) and an associated display.

As illustrated in FIG. 9, the frame 900 may also include a lower relief adjustment mechanism 960 for adjusting a distance between a lower portion of an associated display and a user's eyes. In the example shown in FIG. 9, the lower relief adjustment mechanism 960 may include a cable 962 extending between lower portions of the front frame portion 902 and of the facial interface frame portion 906.

A portion of the cable 962 extending between the front frame portion 902 and the facial interface frame portion 906 may be shortened to reduce a distance between the front frame portion 902 and the facial interface frame portion 906. Conversely, the portion of the cable 962 extending between the front frame portion 902 and the facial interface frame portion 906 may be lengthened to increase a distance between the front frame portion 902 and the facial interface frame portion 906.

For example, the cable 962 may be coupled to a lever arm 964 rotatable between a first position and a second position. When the lever arm 964 is in the first position (e.g., as shown in FIG. 9), the portion of the cable 962 extending between the front frame portion 902 and the facial interface frame portion 906 may be shortened. When the lever arm 964 is in the second position (e.g., rotated downward and toward the right relative to the state shown in FIG. 9), the portion of the cable 962 extending between the front frame portion 902 and the facial interface frame portion 906 may be lengthened.

The shortening of the portion of the cable 962 extending between the front frame portion 902 and the facial interface frame portion 906 may result in the elongated lower support elements 932 bending to bring the facial interface frame portion 906 and the front frame portion 902 closer together. When the portion of the cable 962 extending between the front frame portion 902 and the facial interface frame portion 906 is lengthened, a biasing force (e.g., resilience) of the elongated lower support elements 932 may force the front frame portion 902 away from the facial interface frame portion 906.

Although FIG. 9 illustrates the lower relief adjustment mechanism 960 as including a lever arm 964, the present disclosure is not so limited. In additional examples, the lower relieve adjustment mechanism 960 may include a knob, slider, linear actuator, or other suitable mechanism for applying tension to the cable 962 to reduce a length of the portion of the cable 962 extending between the front frame portion 902 and the facial interface frame portion 906. Conversely, the mechanism may release the tension in the cable 962 to increase a length of the portion of the cable 962 extending between the front frame portion 902 and the facial interface frame portion 906.

FIG. 10 is a bottom perspective view of a frame 1000 for a head-mounted display, according to at least one further embodiment of the present disclosure. In some respects, the frame 1000 may be similar to the frame 900 discussed above with reference to FIG. 9. For example, the frame 1000 may include a front frame portion 1002, a flexible facial interface frame portion 1006, and two upper support elements 1008 that connect an upper portion of the front frame portion 1002 to an upper portion of the facial interface frame portion 1006. Two elongated lower support elements 1032 may connect a lower portion of the front frame portion 1002 and a lower portion of the facial interface frame portion 1006. The frame 1000 may include extendible tabs 1026 for adjusting a distance between an upper portion of the facial interface frame portion 1006 (and, consequently, a user's eyes) and an associated display.

The frame 1000 may include a lower relief adjustment mechanism 1060 for adjusting a distance between a lower portion of an associated display and a user's eyes. In the example shown in FIG. 10, the lower relief adjustment mechanism 1060 may include at least one parallel linkage pair configured to constrain and guide relative movement between the facial interface frame portion 1006 and the front frame portion 1006.

For example, as illustrated in FIG. 10, a first parallel linkage pair 1070 may be rotatably coupled to the lower support element 1032 and the front frame portion 1002. A second parallel linkage pair 1072 may be rotatably coupled to two sections of the front frame portion 1002 above the first parallel linkage pair 1072. At least one linkage from each of the parallel linkage pairs 1070, 1072 may be engaged with each other (e.g., via intermeshed gear teeth), such that rotation of one of the parallel linkage pairs 1070, 1072 results in corresponding rotation of the other of the parallel linkage pairs 1070, 1072. This configuration may facilitate movement (e.g., substantially linear movement) of the lower portion of the front frame portion 1002 between extended and retracted positions.

FIG. 11 is a perspective view of a frame 1100 for a head-mounted display, according to another embodiment of the present disclosure. In some respects, the frame 1100 may be similar to the frames 900 and 1000 discussed above with reference to FIGS. 9 and 10, respectively. For example, the frame 1100 may include a front frame portion 1102, a flexible facial interface frame portion 1106, and two upper support elements 1108 that connect an upper portion of the front frame portion 1102 to an upper portion of the facial interface frame portion 1106. Two lower support elements 1132 may connect a lower portion of the front frame portion 1102 and a lower portion of the facial interface frame portion 1106.

As illustrated in FIG. 11, the frame 1100 may include a relief adjustment mechanism 1170 for adjusting a distance between an associated display and a user's eyes. The relief adjustment mechanism 1170 may be configured to move the front frame portion 1102 away from and/or toward the facial interface frame portion 1106. For example, the relief adjustment mechanism 1170 may include a dual-rack and pinion mechanism 1172 connected to a slider 1174. When a user wishes to adjust an eye relief of the frame 1100, the user may slide the slider 1174, which may result in two racks 1176 on opposing sides of a pinion 1178 translating in opposite directions. The racks 1176 may be connected to respective cables 1180, which may, in turn, be connected to central portions of pivoting members 1182 of the upper support elements 1108 and of the lower support elements 1132. The cables 1180 may pass through guide channels 1183 to direct the cables 1180 around a viewing space through the frame 1100. One end of the pivoting members 1182 may be rotatably coupled to the facial interface frame portion 1106 and an opposing end of the pivoting members 1182 may be slidably coupled to the front frame portion 1102, such as in corresponding slots 1184 of the front frame portion 1102.

As depicted in FIG. 11, when the slider 1174 is positioned to one side (e.g., to the left from the perspective of FIG. 11), the racks 1176 may be moved to apply tension in the cables 1180. This may result in the pivoting members 1182 rotating into a position that extends the front frame portion 1102 away from the facial interface frame portion 1106, such as to provide additional eye relief (e.g., space for glasses). When the slider 1174 is positioned to an opposite side (e.g., to the right from the perspective of FIG. 11), the racks 1176 may be moved to release the tension in the cables 1180. This may result in the pivoting members 1182 rotating into a position that retracts the front frame portion 1102 toward the facial interface frame portion 1106, such as to reduce the eye relief (e.g., for a user who is not wearing glasses).

Because the upper support members 1108 and the lower support members 1132 include the respective pivoting members 1182, the relief adjustment mechanism 1170 may move the front frame portion 1102 relative to the facial interface frame portion 1106 in a substantially parallel movement pattern. In other words, upper portions of the frame 1100 may expand and contract at substantially a same distance and/or rate as lower portions of the frame 1100 when the relief adjustment mechanism 1170 is used. This parallel movement may keep a viewing angle of an associated display substantially the same, regardless of whether the frame 1100 is in an increased eye relief state or in a decreased eye relief state.

Accordingly, the present disclosure includes frames for head-mounted displays that may be capable of conforming to users' facial features of various sizes. The frames may include a facial interface frame element that is configured to flex to conform to the users' facial features. In some examples, a substantially constant eye relief may be maintained even when the head-mounted displays are used with users having significantly different face sizes and shapes. In addition, the present disclosure includes extendible tabs that may be used to adjust a distance between the users eyes and an associated NED. Such extendible tabs may be coupled to the frames, which may eliminate a risk of losing a separate spacer insert.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

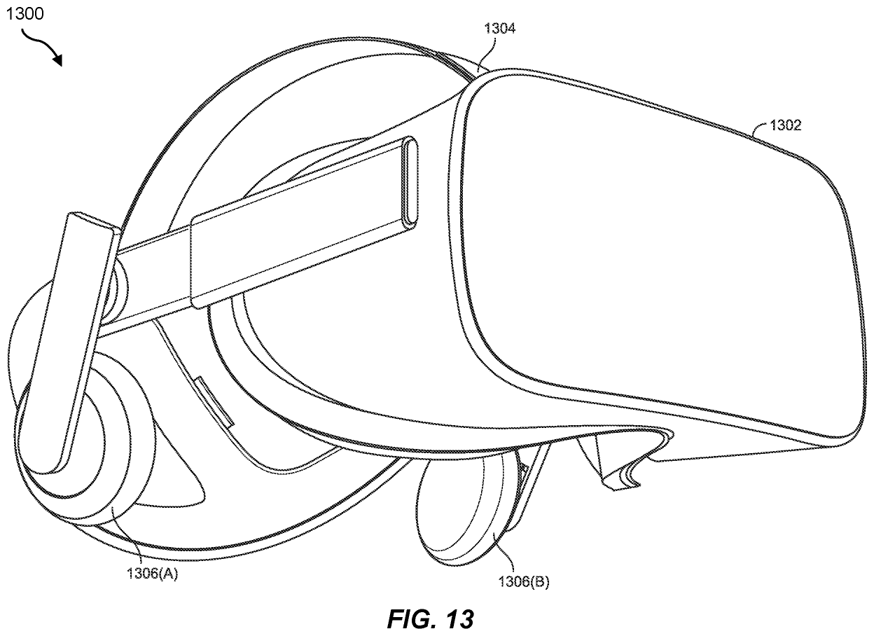

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1200 in FIG. 12) or that visually immerses a user in an artificial reality (such as, e.g., virtual-reality system 1300 in FIG. 13). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 12, the augmented-reality system 1200 may include an eyewear device 1202 with a frame 1210 configured to hold a left display device 1215 (A) and a right display device 1215 (B) in front of a user's eyes. The display devices 1215 (A) and 1215 (B) may act together or independently to present an image or series of images to a user. While the augmented-reality system 1200 includes two displays, embodiments of this disclosure may be implemented in augmented-reality systems with a single NED or more than two NEDs.

In some embodiments, the augmented-reality system 1200 may include one or more sensors, such as sensor 1240. The sensor 1240 may generate measurement signals in response to motion of the augmented-reality system 1200 and may be located on substantially any portion of the frame 1210. The sensor 1240 may represent one or more of a variety of different sensing mechanisms, such as a position sensor, an inertial measurement unit (IMU), a depth camera assembly, a structured light emitter and/or detector, or any combination thereof. In some embodiments, the augmented-reality system 1200 may or may not include the sensor 1240 or may include more than one sensor. In embodiments in which the sensor 1240 includes an IMU, the IMU may generate calibration data based on measurement signals from the sensor 1240. Examples of the sensor 1240 may include, without limitation, accelerometers, gyroscopes, magnetometers, other suitable types of sensors that detect motion, sensors used for error correction of the IMU, or some combination thereof.

In some examples, the augmented-reality system 1200 may also include a microphone array with a plurality of acoustic transducers 1220(A)-1220(J), referred to collectively as acoustic transducers 1220. The acoustic transducers 1220 may represent transducers that detect air pressure variations induced by sound waves. Each acoustic transducer 1220 may be configured to detect sound and convert the detected sound into an electronic format (e.g., an analog or digital format). The microphone array in FIG. 12 may include, for example, ten acoustic transducers: 1220(A) and 1220(B), which may be designed to be placed inside a corresponding ear of the user, acoustic transducers 1220(C), 1220(D), 1220(E), 1220(F), 1220(G), and 1220(H), which may be positioned at various locations on the frame 1210, and/or acoustic transducers 1220(I) and 1220(J), which may be positioned on a corresponding neckband 1205.

In some embodiments, one or more of the acoustic transducers 1220(A)-(J) may be used as output transducers (e.g., speakers). For example, the acoustic transducers 1220(A) and/or 1220(B) may be earbuds or any other suitable type of headphone or speaker.

The configuration of the acoustic transducers 1220 of the microphone array may vary. While the augmented-reality system 1200 is shown in FIG. 12 as having ten acoustic transducers 1220, the number of acoustic transducers 1220 may be greater or less than ten. In some embodiments, using higher numbers of acoustic transducers 1220 may increase the amount of audio information collected and/or the sensitivity and accuracy of the audio information. In contrast, using a lower number of acoustic transducers 1220 may decrease the computing power required by an associated controller 1250 to process the collected audio information. In addition, the position of each acoustic transducer 1220 of the microphone array may vary. For example, the position of an acoustic transducer 1220 may include a defined position on the user, a defined coordinate on the frame 1210, an orientation associated with each acoustic transducer 1220, or some combination thereof.

The acoustic transducers 1220(A) and 1220(B) may be positioned on different parts of the user's ear, such as behind the pinna, behind the tragus, and/or within the auricle or fossa. Or, there may be additional acoustic transducers 1220 on or surrounding the ear in addition to the acoustic transducers 1220 inside the ear canal. Having an acoustic transducer 1220 positioned next to an ear canal of a user may enable the microphone array to collect information on how sounds arrive at the ear canal. By positioning at least two of the acoustic transducers 1220 on either side of a user's head (e.g., as binaural microphones), the augmented-reality system 1200 may simulate binaural hearing and capture a 3D stereo sound field around about a user's head. In some embodiments, the acoustic transducers 1220(A) and 1220(B) may be connected to the augmented-reality system 1200 via a wired connection 1230, and in other embodiments the acoustic transducers 1220(A) and 1220(B) may be connected to the augmented-reality system 1200 via a wireless connection (e.g., a BLUETOOTH connection). In still other embodiments, the acoustic transducers 1220(A) and 1220(B) may not be used at all in conjunction with the augmented-reality system 1200.

The acoustic transducers 1220 on the frame 1210 may be positioned in a variety of different ways, including along the length of the temples, across the bridge, above or below the display devices 1215(A) and 1215(B), or some combination thereof. The acoustic transducers 1220 may also be oriented such that the microphone array is able to detect sounds in a wide range of directions surrounding the user wearing the augmented-reality system 1200.

In some embodiments, an optimization process may be performed during manufacturing of the augmented-reality system 1200 to determine relative positioning of each acoustic transducer 1220 in the microphone array.

In some examples, the augmented-reality system 1200 may include or be connected to an external device (e.g., a paired device), such as the neckband 1205. The neckband 1205 generally represents any type or form of paired device. Thus, the following discussion of the neckband 1205 may also apply to various other paired devices, such as charging cases, smart watches, smart phones, wrist bands, other wearable devices, hand-held controllers, tablet computers, laptop computers, other external compute devices, etc.

As shown, the neckband 1205 may be coupled to the eyewear device 1202 via one or more connectors. The connectors may be wired or wireless and may include electrical and/or non-electrical (e.g., structural) components. In some cases, the eyewear device 1202 and the neckband 1205 may operate independently without any wired or wireless connection between them. While FIG. 12 illustrates the components of the eyewear device 1202 and the neckband 1205 in example locations on the eyewear device 1202 and the neckband 1205, the components may be located elsewhere and/or distributed differently on the eyewear device 1202 and/or the neckband 1205. In some embodiments, the components of the eyewear device 1202 and the neckband 1205 may be located on one or more additional peripheral devices paired with the eyewear device 1202, the neckband 1205, or some combination thereof.

Pairing external devices, such as the neckband 1205, with augmented-reality eyewear devices may enable the eyewear devices to achieve the form factor of a pair of glasses while still providing sufficient battery and computation power for expanded capabilities. Some or all of the battery power, computational resources, and/or additional features of the augmented-reality system 1200 may be provided by a paired device or shared between a paired device and an eyewear device, thus reducing the weight, heat profile, and form factor of the eyewear device overall while still retaining desired functionality. For example, the neckband 1205 may allow components that would otherwise be included on an eyewear device to be included in the neckband 1205 since users may tolerate a heavier weight load on their shoulders than they would tolerate on their heads. The neckband 1205 may also have a larger surface area over which to diffuse and disperse heat to the ambient environment. Thus, the neckband 1205 may allow for greater battery and computation capacity than might otherwise have been possible on a stand-alone eyewear device. Since weight carried in the neckband 1205 may be less invasive to a user than weight carried in the eyewear device 1202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

The neckband 1205 may be communicatively coupled with the eyewear device 1202 and/or to other devices. These other devices may provide certain functions (e.g., tracking, localizing, depth mapping, processing, storage, etc.) to the augmented-reality system 1200. In the embodiment of FIG. 12, the neckband 1205 may include two acoustic transducers (e.g., 1220(I) and 1220(J)) that are part of the microphone array (or potentially form their own microphone subarray). The neckband 1205 may also include a controller 1225 and a power source 1235.

The acoustic transducers 1220(1) and 1220(J) of the neckband 1205 may be configured to detect sound and convert the detected sound into an electronic format (analog or digital). In the embodiment of FIG. 12, the acoustic transducers 1220(l) and 1220(J) may be positioned on the neckband 1205, thereby increasing the distance between the neckband acoustic transducers 1220(I) and 1220(J) and other acoustic transducers 1220 positioned on the eyewear device 1202. In some cases, increasing the distance between the acoustic transducers 1220 of the microphone array may improve the accuracy of beamforming performed via the microphone array. For example, if a sound is detected by the acoustic transducers 1220(C) and 1220(D) and the distance between the acoustic transducers 1220(C) and 1220(D) is greater than, e.g., the distance between the acoustic transducers 1220(D) and 1220(E), the determined source location of the detected sound may be more accurate than if the sound had been detected by the acoustic transducers 1220(D) and 1220(E).

The controller 1225 of the neckband 1205 may process information generated by the sensors on the neckband 1205 and/or the augmented-reality system 1200. For example, the controller 1225 may process information from the microphone array that describes sounds detected by the microphone array. For each detected sound, the controller 1225 may perform a direction-of-arrival (DOA) estimation to estimate a direction from which the detected sound arrived at the microphone array. As the microphone array detects sounds, the controller 1225 may populate an audio data set with the information. In embodiments in which the augmented-reality system 1200 includes an inertial measurement unit, the controller 1225 may compute all inertial and spatial calculations from the IMU located on the eyewear device 1202. A connector may convey information between the augmented-reality system 1200 and the neckband 1205 and between the augmented-reality system 1200 and the controller 1225. The information may be in the form of optical data, electrical data, wireless data, or any other transmittable data form. Moving the processing of information generated by the augmented-reality system 1200 to the neckband 1205 may reduce weight and heat in the eyewear device 1202, making it more comfortable to the user.

The power source 1235 in the neckband 1205 may provide power to the eyewear device 1202 and/or to the neckband 1205. The power source 1235 may include, without limitation, lithium ion batteries, lithium-polymer batteries, primary lithium batteries, alkaline batteries, or any other form of power storage. In some cases, the power source 1235 may be a wired power source. Including the power source 1235 on the neckband 1205 instead of on the eyewear device 1202 may help better distribute the weight and heat generated by the power source 1235.

As noted, some artificial-reality systems may, instead of blending an artificial reality with actual reality, substantially replace one or more of a user's sensory perceptions of the real world with a virtual experience. One example of this type of system is a head-worn display system, such as the virtual-reality system 1300 in FIG. 13, that mostly or completely covers a user's field of view. The virtual-reality system 1300 may include a front rigid body 1302 and a band 1304 shaped to fit around a user's head. The virtual-reality system 1300 may also include output audio transducers 1306(A) and 1306(B). Furthermore, while not shown in FIG. 13, the front rigid body 1302 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in the augmented-reality system 1200 and/or the virtual-reality system 1300 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in the augmented-reality system 1200 and/or the virtual-reality system 1300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, the augmented-reality system 1200 and/or the virtual-reality system 1300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (e.g., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance.

Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The following example embodiments are also included in the present disclosure.

Example 1: A frame for a head-mounted display, which may include: a front frame portion dimensioned to physically support a near-eye display (NED); a flexible facial interface frame portion with outer peripheral regions configured to flex to conform to a user's facial features when in use; and two upper support elements connecting an upper portion of the front frame portion and an upper portion of the flexible facial interface frame portion, wherein the two upper support elements intersect with the flexible facial interface frame portion respectively at a first intersection point and a second intersection point.

Example 2: The frame of Example 1, wherein the flexible facial interface frame portion includes a central beam between the first and second intersection points, wherein the central beam flexes forward when the outer peripheral regions flex backward and the central beam flexes backward when the outer peripheral regions flex forward.

Example 3: The frame of Example 1 or Example 2, wherein a first distance between the front frame portion and the first intersection point and a second distance between the front frame portion and the second intersection point are maintained substantially the same by the two upper support elements when the outer peripheral regions are flexed forward and backward to conform to the user's facial features.

Example 4: The frame of any of Examples 1 through 3, wherein each upper support element of the two upper support elements are curved laterally inward.

Example 5: The frame of any of Examples 1 through 4, wherein the first and second intersection points are separated from each other by a distance between 50 mm and 75 mm.

Example 6: The frame of any of Examples 1 through 5, wherein the front frame portion, flexible facial interface frame portion, and two upper support elements are parts of an integral, unitary facial interface frame body.

Example 7: The frame of Example 6, further including a display interface frame body separate from the integral, unitary facial interface frame body, wherein the display interface frame body is configured to be positioned between, and to couple, the NED and the integral, unitary facial interface frame body.

Example 8: A head-mounted display, which may include: a near-eye display (NED) for presenting images to a user; and a facial interface frame element, including: a front frame portion dimensioned to physically support the NED; a flexible facial interface frame portion with outer peripheral regions configured to flex to conform to a user's facial features when the head-mounted display is worn by the user; and two upper support elements extending between an upper portion of the front frame portion and an upper portion of the flexible facial interface frame portion, wherein the two upper support elements intersect with the flexible facial interface frame portion respectively at a first intersection point and a second intersection point.

Example 9: The head-mounted display of Example 8, wherein the facial interface frame element lacks any additional support elements between the flexible facial interface frame portion and the front frame portion laterally outside of the two upper support elements.

Example 10: The head-mounted display of Example 8 or Example 9, wherein the two upper support elements are curved laterally inward.

Example 11: The head-mounted display of any of Examples 8 through 10, wherein the first and second intersection points are separated by a distance between 50 mm and 75 mm.

Example 12: The head-mounted display of any of Examples 8 through 11, wherein the first and second intersection points are separated by a distance between 64 mm and 68 mm.

Example 13: The head-mounted display of any of Examples 8 through 12, wherein the NED is configured to present stereoscopic images to the user.

Example 14: The head-mounted display of any of Examples 8 through 13, wherein the facial interface frame element further includes at least one lower support element connecting a lower portion of the front frame portion and a lower portion of the flexible facial interface frame portion.

Example 15: The head-mounted display of Example 14, wherein the at least one lower support element includes two lower support elements.

Example 16: The head-mounted display of Example 15, wherein the two lower support elements are separated by a distance less than the distance between the first and second intersection points.

Example 17: The head-mounted display of any of Examples 8 through 16, further including an extensible material disposed between the front frame portion and the flexible facial interface frame portion and configured to extend upon flexing of the flexible facial interface frame portion away from the front frame portion and to retract upon flexing of the flexible facial interface frame portion toward the front frame portion.

Example 18: The head-mounted display of Example 17, wherein the extensible material includes a flexible fabric material.

Example 19: The head-mounted display of any of Examples 8 through 18, wherein the front frame portion, flexible facial interface frame portion, and two upper support elements are parts of an integral, unitary frame body.

Example 20: A head-mounted display, which may include: a near-eye display (NED) for presenting images to a user; and a facial interface frame element, including: a front frame portion dimensioned to physically support the NED; a flexible facial interface frame portion with outer peripheral regions configured to flex to conform to the user's facial features when worn; and at least two support elements extending between the front frame portion and the flexible facial interface frame portion, wherein: the two support elements intersect with the flexible facial interface frame portion respectively at a first intersection point and a second intersection point, the first and second intersection points are separated by a distance between 50 mm and 75 mm, and the facial interface frame element lacks any support elements between the front frame portion and the outer peripheral regions of the flexible facial interface frame portion.

Example 21: A frame assembly for a head-mounted display, which frame assembly may include: a facial interface frame configured to rest against a user's face while wearing the head-mounted display; a display support frame configured to support a near-eye display; and at least one extendible that movably couples the facial interface frame to the display support frame, wherein the at least one extendible tab is movable between a retracted position at which the near-eye display is located a first distance from the facial interface frame and an extended position at which the near-eye display is located a second, greater distance from the facial interface frame.

Example 22: The frame assembly of Example 21, wherein the at least one extendible tab may include at least two extendible tabs.

Example 23: The frame assembly of Example 22, wherein the at least two extendible tabs may include two upper extendible tabs coupled to upper portions of the facial interface frame and of the display support frame.

Example 24: The frame assembly of any one of Examples 21 through 23, wherein the at least one extendible tab is slidably coupled to the facial interface frame.

Example 25: The frame assembly of any one of Examples 21 through 24, wherein the facial interface frame may include a flexible facial interface frame portion configured to flex to conform to facial features of the user.

Example 26: The frame assembly of any one of Examples 21 through 25, wherein the at least one extendible tab may include a surface feature to provide additional traction for pressing and sliding the at least one extendible tab.

Example 27: The frame assembly of Example 26, wherein the surface feature may include at least one of: knurling; ridges; a depression; a lip; and/or surface roughness.

Example 28: The frame assembly of any one of Examples 21 through 27, wherein the at least one extendible tab may include flanges that are shaped and sized for positioning within respective grooves of the facial interface frame.

Example 29: The frame assembly of any one of Examples 21 through 28, wherein: the at least one extendible tab may include a locking protrusion; the facial interface frame may include a retracted locking surface for the locking protrusion to abut against when the at least one extendible tab is in the retracted position; and the facial interface frame further may include an extended locking surface for the locking protrusion to abut against when the at least one extendible tab is in the extended position.

Example 30: The frame assembly of any one of Examples 21 through 29, wherein: the at least one extendible tab may include a locking protrusion; and the facial interface frame may include a retention tab against which the at least one extendible tab abuts to retain the at least one extendible tab coupled to the facial interface frame.

Example 31: A head-mounted display, which may include: a near-eye display (NED) for presenting images to a user; and a frame assembly, which may include: a facial interface frame configured to rest against a user's face while wearing the head-mounted display; a display support frame separate from the facial interface frame, the display support frame supporting the NED; and at least one extendible tab that movably coupled the facial interface frame to the display support frame, wherein the at least one extendible tab is movable between a retracted position at which the near-eye display is located a first distance from the facial interface frame and an extended position at which the near-eye display is located a second, greater distance from the facial interface frame.

Example 32: The head-mounted display of Example 31, wherein the facial interface frame may include a flexible facial interface frame portion configured to flex to conform to facial features of the user.

Example 33: The head-mounted display of Example 32, wherein the facial interface frame may further include a front frame portion configured to interface with the display support frame.

Example 34: The head-mounted display of Example 33, wherein the facial interface frame may further include two upper support elements extending between the front frame portion and the flexible facial interface frame portion.

Example 35: The head-mounted display of any one of Examples 31 through 34, wherein: the at least one extendible tab may include a locking protrusion; the facial interface frame may include a retracted locking surface for the locking protrusion to abut against when the at least one extendible tab is in the retracted position; and the facial interface frame further may include an extended locking surface for the locking protrusion to abut against when the at least one extendible tab is in the extended position.

Example 36: The head-mounted display of any one of Examples 31 through 35, wherein the at least one extendible tab may include two extendible tabs.

Example 37: The head-mounted display of Example 36, wherein the two extendible tabs are positioned to be coupled to an upper portion of the facial interface frame and an upper portion of the display support frame.

Example 38: The head-mounted display of any one of Examples 31 through 37, wherein a distance that the at least one extendible tab extends is sufficient to accommodate glasses worn by the user.

Example 39: The head-mounted display of any one of Examples 31 through 38, wherein the at least one extendible tab is slidably coupled to the facial interface frame.

Example 40: A head-mounted display, which may include: a near-eye display (NED) for presenting images to a user; and a frame assembly, which may include: a facial interface frame including a flexible facial interface frame portion with outer peripheral regions configured to flex to conform to facial features of the user when the head-mounted display is worn; a display support frame supporting the NED; and two upper extendible tabs slidably coupled to an upper region of the facial interface frame and coupled to an upper region of the display support frame, wherein the two extendible tabs are movable between a retracted position holding the display support frame at a first position adjacent to the facial interface frame and an extended position holding the display support frame at a second position further from the facial interface frame.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A frame assembly for a head-mounted display, the frame assembly comprising:
a facial interface frame configured to rest against a user's face while wearing the head-mounted display;
a display support frame configured to support a near-eye display; and
at least one extendible tab that movably couples the facial interface frame to the display support frame, wherein the at least one extendible tab is movable between a retracted position at which the near-eye display is located a first distance from the facial interface frame and an extended position at which the near-eye display is located a second, greater distance from the facial interface frame.

2. The frame assembly of claim 1, wherein the at least one extendible tab comprises at least two extendible tabs.

3. The frame assembly of claim 2, wherein the at least two extendible tabs comprise two upper extendible tabs coupled to upper portions of the facial interface frame and of the display support frame.

4. The frame assembly of claim 1, wherein the at least one extendible tab is slidably coupled to the facial interface frame.

5. The frame assembly of claim 1, wherein the facial interface frame comprises a flexible facial interface frame portion configured to flex to conform to facial features of the user.

6. The frame assembly of claim 1, wherein the at least one extendible tab comprises a surface feature to provide additional traction for pressing and sliding the at least one extendible tab.

7. The frame assembly of claim 6, wherein the surface feature comprises at least one of:
knurling;
ridges;
a depression;
a lip; or
surface roughness.

8. The frame assembly of claim 1, wherein the at least one extendible tab comprises flanges that are shaped and sized for positioning within respective grooves of the facial interface frame.

9. The frame assembly of claim 1, wherein:
the at least one extendible tab comprises a locking protrusion;
the facial interface frame comprises a retracted locking surface for the locking protrusion to abut against when the at least one extendible tab is in the retracted position; and
the facial interface frame further comprises an extended locking surface for the locking protrusion to abut against when the at least one extendible tab is in the extended position.

10. The frame assembly of claim 1, wherein:
the at least one extendible tab comprises a locking protrusion; and
the facial interface frame comprises a retention tab against which the at least one extendible tab abuts to retain the at least one extendible tab coupled to the facial interface frame.

11. A head-mounted display, comprising:
a near-eye display (NED) for presenting images to a user; and
a frame assembly, comprising:
a facial interface frame configured to rest against a user's face while wearing the head-mounted display;
a display support frame separate from the facial interface frame, the display support frame supporting the NED; and
at least one extendible tab that movably coupled the facial interface frame to the display support frame, wherein the at least one extendible tab is movable between a retracted position at which the near-eye display is located a first distance from the facial interface frame and an extended position at which the near-eye display is located a second, greater distance from the facial interface frame.

12. The head-mounted display of claim 11, wherein the facial interface frame comprises a flexible facial interface frame portion configured to flex to conform to facial features of the user.

13. The head-mounted display of claim 12, wherein the facial interface frame further comprises a front frame portion configured to interface with the display support frame.

14. The head-mounted display of claim 13, wherein the facial interface frame further comprises two upper support elements extending between the front frame portion and the flexible facial interface frame portion.

15. The head-mounted display of claim 11, wherein:
the at least one extendible tab comprises a locking protrusion;
the facial interface frame comprises a retracted locking surface for the locking protrusion to abut against when the at least one extendible tab is in the retracted position; and
the facial interface frame further comprises an extended locking surface for the locking protrusion to abut against when the at least one extendible tab is in the extended position.

16. The head-mounted display of claim 11, wherein the at least one extendible tab comprises two extendible tabs.

17. The head-mounted display of claim 16, wherein the two extendible tabs are positioned to be coupled to an upper portion of the facial interface frame and an upper portion of the display support frame.

18. The head-mounted display of claim 11, wherein a distance that the at least one extendible tab extends is sufficient to accommodate glasses worn by the user.

19. The head-mounted display of claim 11, wherein the at least one extendible tab is slidably coupled to the facial interface frame.

20. A head-mounted display, comprising:
a near-eye display (NED) for presenting images to a user; and
a frame assembly, comprising:
a facial interface frame including a flexible facial interface frame portion with outer peripheral regions configured to flex to conform to facial features of the user when the head-mounted display is worn;
a display support frame supporting the NED; and
two upper extendible tabs slidably coupled to an upper region of the facial interface frame and coupled to an upper region of the display support frame, wherein the two extendible tabs are movable between a retracted position holding the display support frame at a first position adjacent to the facial interface frame and an extended position holding the display support frame at a second position further from the facial interface frame.
